(19) United States
(12) Patent Application Publication
(10) Pub. No.: US 2012/0282796 A1
(43) Pub. Date: Nov. 8, 2012

(54) PLUG CONNECTOR HAVING IMPROVED RELEASING MECHANISM AND A CONNECTOR ASSEMBLY HAVING THE SAME

(75) Inventors: JERRY WU, Irvine, CA (US); PENG ZHAI, Kunshan (CN)

(73) Assignee: HON HAI PRECISION INDUSTRY CO., LTD., New Taipei (TW)

(21) Appl. No.: 13/462,061

(22) Filed: May 2, 2012

(30) Foreign Application Priority Data
May 4, 2011 (CN) 201110114479.8

(51) Int. Cl. H01R 13/627

(52) U.S. Cl. 439/350

(57) ABSTRACT

A connector assembly includes a receptacle (300) having a latching tab (30) extending inwardly and forwardly, and a plug connector (100) adapted for mating and latching with the receptacle. The plug connector includes a housing (1) defining an outer surface (110), and a releasing mechanism (2) having a slider (20) movably attached to the housing. The outer surface has a recess (10) defining a shoulder portion (101) configured for resisting against the latching tab in a backward direction. The slider has an ejector end (21) extends forwardly and outwardly. The recess has a ramped surface (1020) configured for leading the ejector end moving backwardly and outwardly to release the latching tab from the shoulder portion.

### BACKGROUND OF THE INVENTION

1. Field of the Invention

The present invention relates to a plug connector and a connector assembly, and more particularly to a SFP (Small Form-Factor Pluggable) plug connector adapted for latching with a receptacle, and a connector assembly including the plug connector and the receptacle.

2. Description of Related Art

U.S. Pat. No. 6,908,323 issued to Ice on Jun. 21, 2005 discloses an electronic module mating with a receptacle. The receptacle has a shielding cage defining a cavity for receiving the electronic module and a pair of opposing latching tabs extending inwardly for latching with the electronic module. The electric module includes a housing and a latch mechanism movably attached to the housing. The housing has two parallel sidewalls. Each of the sidewalls defines a recess. Each of the recesses forms a step for resisting against the latching tab thus keeping the electronic module in the receptacle. The latch mechanism comprises a pair of sliders having an actuating end configured for releasing the latching tabs from the step. Each of the sliders is received in the recess and configured for sliding from a latching position to a releasing position.

U.S. Pat. No. 6,851,867 issued to Pang et al. on Feb. 8, 2005 discloses a fiber optic module. The fiber optic module has a release mechanism movably attached to a housing adapted to be received in a receptacle cage. The receptacle cage has a pair of latching tabs extending inwardly and forwardly. The latching tab is resisted into the housing for locking the fiber optic module in the receptacle cage. The release mechanism has a pair of sliding actuators configured for releasing the pair of latching tabs. Each of the sliding actuators has an actuating end adapted to be moved from a latching position to a releasing position in order to release the latching tab from the housing.

Both the latching position and the releasing position in above-mentioned latch mechanism or release mechanism are configured for moving along a straight line parallel to an outer surface of the sidewall. With repeated use, the actuating end might wear out or be unable to effectively push the latching tab out of the step completely.

Hence, a plug connector having an improved releasing mechanism is desired.

### SUMMARY OF THE INVENTION

Accordingly, an object of the present invention is to provide a plug connector having a reliable releasing mechanism, and a connector assembly having the same.

In order to achieve the above-mentioned object, a plug connector is configured for mating with a receptacle along a front-to-back direction. The receptacle has an inwardly extending latching tab configured for latching the plug connector. The plug connector includes a housing defining an outer surface having an elongated recess, and a releasing mechanism assembled to the housing. The recess has a pair of parallel sidewalls and a shoulder portion configured for resisting against the latching tab in a backward direction. At least one guide slot sidewardly extends into one of the sidewalls. The releasing mechanism comprises a slider movably attached to the housing. The slider has an elongated actuating arm received in the recess, and an ejector end extending forwardly and outwardly from the front of the actuating arm, and at least one guide portion sidewardly extending nearby the ejector end. The guide portion is received into the guide slot. The ejector end is adapted to be moveable from a first position to a second position, and configured for releasing the latching tab from the shoulder portion. The recess further has a ramped surface extending forwardly and inwardly adjacent to the shoulder portion. The ramped surface is configured for leading the guide portion moving together with the ejector end backwardly and outwardly from the first position to the second position. The ejector end could release the latching tab from the shoulder portion completely, thus the plug connector has a reliable releasing mechanism.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an assembled perspective view showing a plug connector having a releasing mechanism in accordance with the present invention;

FIG. 2 is an assembled perspective view showing a housing of the plug connector as shown in FIG. 1;

FIG. 3 is an exploded perspective view showing the plug connector as shown in FIG. 1;

FIGS. 4-5 are perspective views showing the top cover and the bottom cover as shown in FIG. 2;

FIG. 6 is an enlarged view showing the guide slot marked by a circle in FIG. 2; and

FIG. 7 is an assembled perspective view showing a receptacle having a latching tab in accordance with the present invention.

### DETAILED DESCRIPTION OF THE PREFERRED EMBODIMENT

Reference will now be made to the drawing figures to describe the present invention in detail.

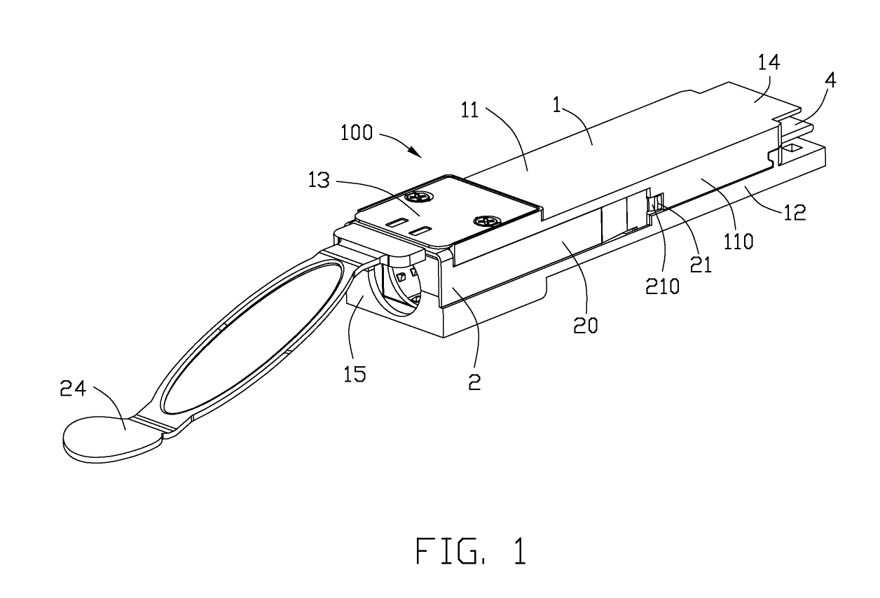

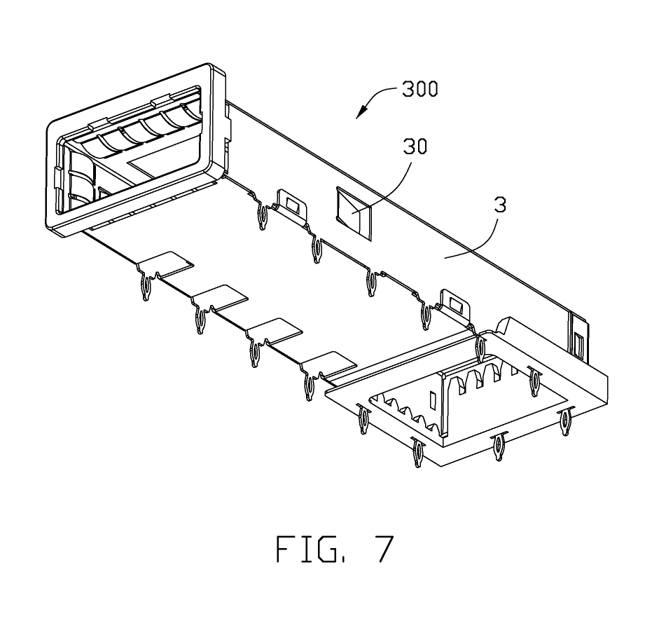

Referring to FIGS. 1 and 7, a connector assembly in accordance with the present invention includes a plug connector 100 and a receptacle 300 configured for receiving the plug connector 100. The receptacle 300, which primarily includes a cage 3, has a latching tab 30 on either side thereof extending inwardly and forwardly. The plug connector 100 comprises a housing 1 and a releasing mechanism 2. The releasing mechanism 2 is assembled to the housing 1 by mounting a pair of screws 131 into the housing 1. A cover plate 13 is attached to the housing 1 for preventing the releasing mechanism 2 escaping from the housing 1. The housing 1 of the plug connector 100 has a front mating portion 14 adapted to be inserted into the receptacle 300, and a rear connecting portion 15 configured for connecting with a cable or a fiber. The plug connector 100 is configured for mating and latching with the receptacle along a front-to-back direction.

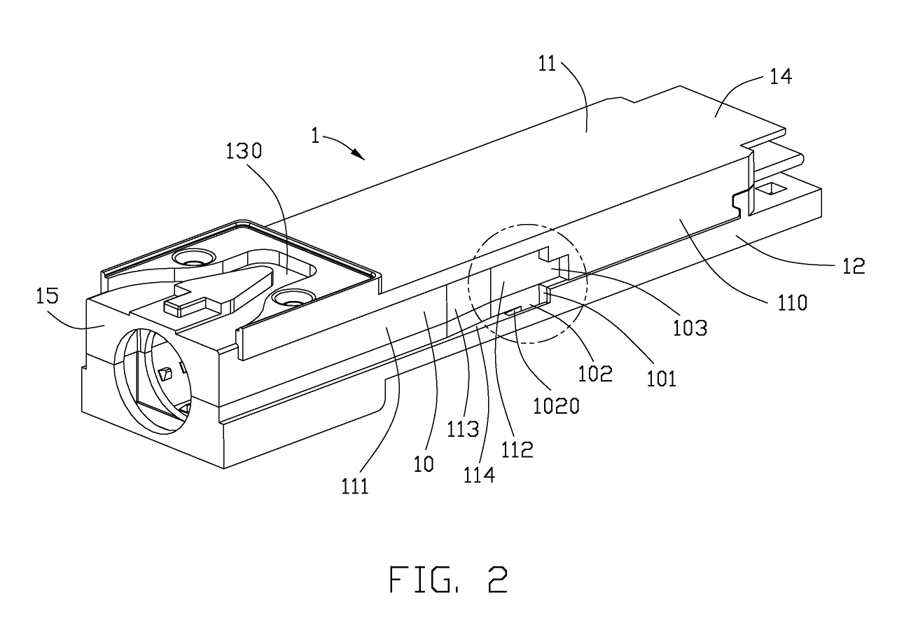

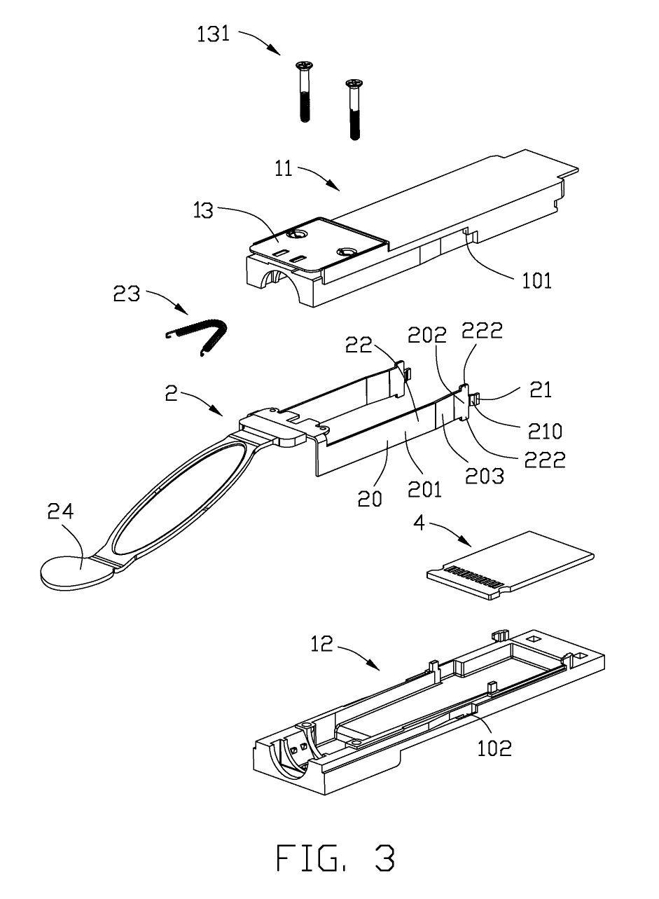

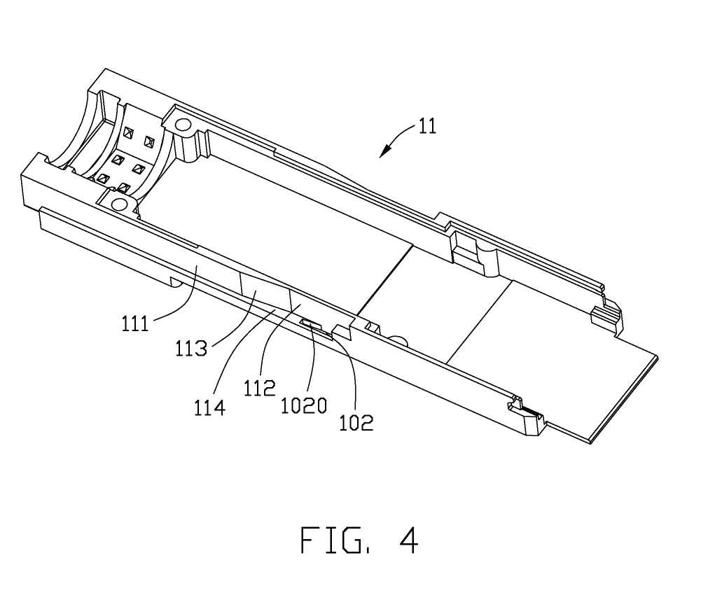

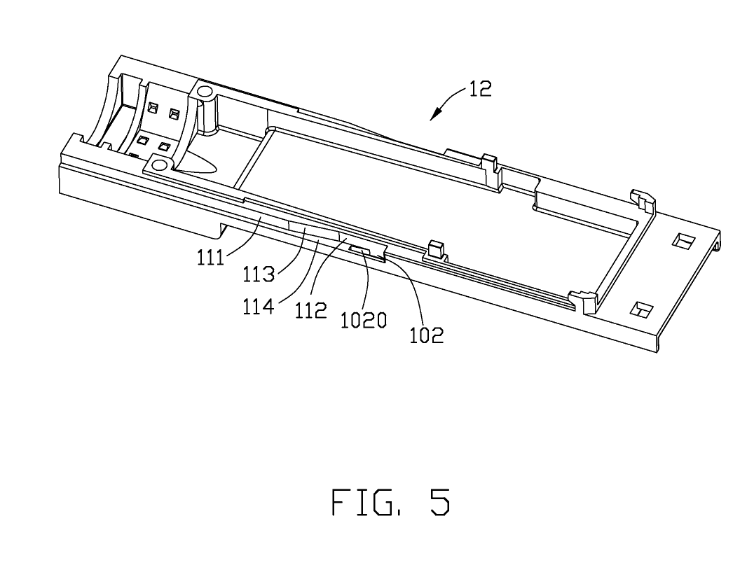

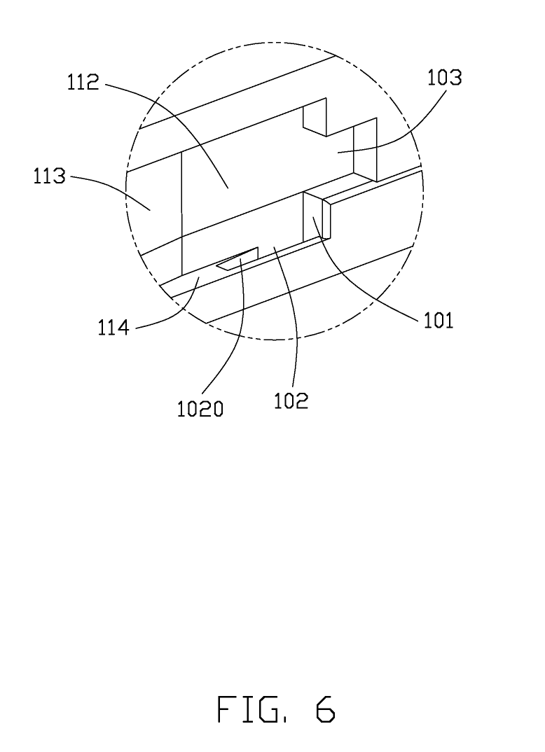

Referring to FIGS. 2 to 6, the housing 1 comprises a first cover 11 and a second cover 12 coupled with each other. The first cover 11 and the second cover 11 define a cavity (not labeled) there-between configured for receiving a printed circuit board 4. The printed circuit board 4 mates with the receptacle 300 configured for transmitting signals.

In conjunction with FIG. 2, the housing 1 has two opposite outer surface 110 between the front mating portion 14 and the rear connecting portion 15. The outer surface 110 defines an elongated recess 10 extending along the front-to-back direction. The recess 10 has a bottom surface 111 and a pair of parallel sidewalls 114. Each of the sidewalls 114 is positioned on one of the first cover 11 and the second cover 12 respectively and configured for defining the recess 10. The outer surface 10 further defines an indentation 103 forwardly extending from the recess 10. The indentation 103 has a width smaller than that of the recess 10 to form a shoulder portion 101. The shoulder portion 101 is configured for backwardly resisting against the latching tab 30 when the plug connector 100 is fully inserted into the receptacle 300.

In conjunction with FIGS. 2, 4, and 6, a guide slot 102 sidewardly extending into the sidewall 114 adjacent to the indentation 103. A ramped surface 1020 is formed in the guide slot 102 and configured for extending forwardly and inwardly. The recess 10 further includes a inner surface 112 and a transition surface 113 configured for connecting the bottom surface 111 and the inner surface 112. The bottom surface 111 is positioned between the outer surface 110 and the inner surface 112. Thus, a space behind the shoulder portion 101 and between the inner surface 112 and outer surface 110 is defined for receiving the latching tab 30.

The releasing mechanism 2 comprises a pair of sliders 20 respectively attached to the recesses 10 and movable relative to the housing 1 along the front-to-back direction. The slider 20 has an elongated actuating arm 22 and an ejector end 21 extending forwardly and outwardly from an front end of the actuating arm 22. The ejector end 21 is adapted to be moveable together with the actuating arm 22 from a latching position to a releasing position for releasing the latching tab 30 from the shoulder portion 101. A pair of guide portions 222 sidewardly extending from the actuating arm 22 nearby the ejector end 21. The guide portion 222 is adapted to be movably received into the guide slot 102. The actuating arm 22 comprises an actuating portion 201, an actuating end 202 and a connection portion 203 connecting the actuating portion 201 and the actuating end 202 together. The ejector end 21 has a leading surface 210 extending forwardly and outwardly from the guide portion 222. The ejector end 21 is adapted to be received into the indentation 103 and extruding beyond the latching tab 30 at the front-to-back direction when the plug connector 100 is fully inserted into the receptacle 300.

The releasing mechanism 2 further includes an operator 24 configured for connecting the sliders 20 together and configured for actuating the sliders 20 from the latching position to the releasing position, and an elastic element 23 connected to the sliders 20 configured for restoring the sliders 20 moving from the releasing position back to the latching position. The elastic element 23 is received in a channel 130 on the first cover 11. The elastic element 23 is fixed in the channel 130 when the cover plate 13 is locked by the screws 131.

In the preferred embodiment, the actuating portion 201 of the actuating arm 20 is positioned on the bottom surface 111. The actuating end 202 of the actuating arm 20 is positioned on the inner surface 112. And the connection portion 203 of the actuating arm 20 is positioned on the transition surface 113. However, in alternative embodiment, the actuating arm 20 could be a straight sliding member when the recess 10 is configured for having a flat bottom.

When the slider 20 is actuated from the latching position to the releasing position, the guide portion 222 would move along the ramped surface 1020 backwardly and outwardly. Thus, the latching tab 30 would be released from the shoulder portion 101 completely when the slider 20 is pulled.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A plug connector configured for mating with a receptacle having a latching tab extending inwardly, comprising:
a housing having a front mating portion adapted to be inserted into the receptacle along a forward direction, said housing having an outer surface, the outer surface defining a recess, said recess having:
a pair of parallel sidewalls;
a shoulder portion configured for resisting against the latching tab in a backward direction; and
at least one guide slot sidewardly extending into the sidewalls; and
a releasing mechanism comprising a slider movably attached to the housing, the slider including:
an elongated actuating arm;
an ejector end extending forwardly and outwardly from a front end of the actuating arm; and
at least one guide portion sidewardly extending from the actuating arm nearby the ejector end and received into the at least one guide slot; wherein
the recess has a ramped surface extending forwardly and inwardly adjacent to the shoulder portion, and said ramped surface is configured for guidingly moving the guide portion together with the ejector end backwardly and outwardly to release the latching tab from the shoulder portion.

2. The plug connector as claimed in claim 1, wherein the housing comprises a first cover and a second cover coupled with each other and defining a cavity therebetween.

3. The plug connector as claimed in claim 2, wherein each of the sidewalls is formed on a corresponding one of the first cover and the second cover, and the ramped surface is positioned in the at least one guide slot.

4. The plug connector as claimed in claim 1, wherein the housing has two opposite outer surfaces, and the releasing mechanism comprises two sliders attached to the outer surfaces respectively.

5. The plug connector as claimed in claim 4, wherein the releasing mechanism comprises an operator connecting the two sliders.

6. The plug connector as claimed in claim 1, wherein the releasing mechanism includes an elastic element connected to the slider.

7. The plug connector as claimed in claim 1, wherein the outer surface has an indentation forwardly of the recess and configured for receiving the ejector end, the indentation having a width smaller than that of the recess to thereby form the shoulder portion.

8. The plug connector as claimed in claim 1, wherein the ejector end has a leading surface extending forwardly and outwardly from the front end of the actuating arm and operable to actuate the latching tab.

9. A connector assembly comprising:
a receptacle having a latching tab extending inwardly and forwardly therein; and
a plug connector configured for mating with the receptacle along a front-to-back direction comprising:
a housing having a front mating portion adapted to be inserted into the receptacle along a forward direction, said housing having an outer surface, the outer surface defining a recess, said recess having:
a pair of parallel sidewalls;
a shoulder portion configured for resisting against the latching tab in a backward direction; and
at least one guide slot sidewardly extending into the sidewalls; and
a releasing mechanism comprising a slider movably attached to the housing, the slider including:
an elongated actuating arm;
an ejector end extending forwardly and outwardly from a front end of the actuating arm; and
at least one guide portion sidewardly extending from the actuating arm nearby the ejector end and received into the at least one guide slot; wherein
the recess has a ramped surface extending forwardly and inwardly adjacent to the shoulder portion, and said ramped surface is configured for guidingly moving the guide portion together with the ejector end backwardly and outwardly to release the latching tab from the shoulder portion.

10. The connector assembly as claimed in claim 9, wherein the housing comprises a first cover and a second cover coupled with each other and defining a cavity therebetween.

11. The connector assembly as claimed in claim 10, wherein each of the sidewalls is formed on a corresponding one of the first cover and the second cover, and the ramped surface is positioned in the at least one guide slot.

12. The connector assembly as claimed in claim 9, wherein the housing has two opposite outer surfaces, and the releasing mechanism comprises two sliders attached to the outer surfaces respectively.

13. The connector assembly as claimed in claim 12, wherein the releasing mechanism comprises an operator connecting the two sliders.

14. The connector assembly as claimed in claim 9, wherein the releasing mechanism includes an elastic element connected to the slider.

15. The connector assembly as claimed in claim 9, wherein the outer surface has an indentation forwardly of the recess and configured for receiving the ejector end, the indentation having a width smaller than that of the recess to thereby form the shoulder portion.

16. The connector assembly as claimed in claim 9, wherein the ejector end has a leading surface extending forwardly and outwardly from the front end of the actuating arm and operable to actuate the latching tab.

17. A plug connector comprising:
a housing defining two opposite side faces and a opposite top and bottom faces with a mating port therein;
a cable extending out of a rear end of the housing;
a recess formed in each of the side faces and defining a front locking shoulder, a large primary inclined transition surface and a small secondary ramp surface in front of the large primary inclined transition surface; and
a releasing mechanism defining a slider back and forth moveable along the recess, said slider defining an actuating arm with an ejection end at a free end which is regularly located in front of the locking shoulder, a connection portion moveable along the large primary inclined transition surface, and an actuation end between the ejection end and the connection portion and moveable along the small secondary ramp surface; wherein
an initial outward deflection of the ejection end results from abutment of the connection portion against the large primary inclined transition surface, and a successive outward deflection of the ejection end further results from abutment of the actuation end against the small secondary ramp surface to finalize said outward deflection.

18. The plug connector as claimed in claim 17, wherein the actuating end is further equipped with a guide portion which is received in a slit of the housing for guidance and abuts against said small secondary ramp surface.

19. The plug connector as claimed in claim 18, wherein the releasing mechanism further includes an operation tab around a top face.

20. The plug connector as claimed in claim 19, wherein the actuating end is angled with the connection portion.
